(19) United States
(12) Patent Application Publication
(10) Pub. No.: US 2024/0274039 A1
(43) Pub. Date: Aug. 15, 2024

(54) SURGICAL TRAINING MODEL

(71) Applicant: FUSETEC 3D PTY LTD, Adelaide (AU)

(72) Inventors: Mark ROE, Adelaide (AU); Sammuel SOBEY, Adelaide (AU); Nicholas LITCHFIELD, Adelaide (AU)

(21) Appl. No.: 18/647,259

(22) Filed: Apr. 26, 2024

Related U.S. Application Data
(63) Continuation-in-part of application No. 18/292,958, filed on Jan. 1, 0001.

(30) Foreign Application Priority Data
Jul. 29, 2021 (AU) 2021902330
Apr. 28, 2023 (AU) 2023202629

(51) Int. Cl. G09B 23/34; G09B 23/32

(52) U.S. Cl. CPC G09B 23/34; G09B 23/32

(57) ABSTRACT

A surgical training model is provided comprising a plurality of removable spacer cassettes that when arranged together simulate a spine. Each spacer cassette is removable and replaceable with an anatomy cassette that simulates an anatomy and or pathology in the spine.

This application is a continuation-in-part of U.S. patent application Ser. No. 18/292,958 filed Jan. 29, 2024, entitled “Surgical Training Model,” which is a national phase application under 35 U.S.C. § 371 of PCT/AU2022/050803 filed Jul. 29, 2022, which claims the benefit of and priority to Australian Patent Application No. 2021902330 filed Jul. 29, 2021. The application further claims the benefit of and priority to Australian Patent Application No. 2022268359 filed Jul. 29, 2022 entitled “Surgical Training Model.” The contents of all of which are hereby incorporated by reference in their entireties herein.

### TECHNICAL FIELD

The present disclosure relates to a surgical training model which can be used by surgeons, educators, trainers and/or students in the healthcare and human sciences fields for the purpose of surgical training, teaching and learning.

### BACKGROUND

Surgical training models are fast becoming an adjunct to, and in some cases a replacement for cadavers and wet specimens in a wide range of demonstration and training environments.

Anatomy is considered the cornerstone of medicine. Cadavers and wet specimens have been an important gross anatomy teaching tool for many sciences and healthcare professions since the 15^{th} Century. In addition to teaching anatomy, in recent years, cadavers have replaced live patients in surgical training. However, ethical issues, harmful bacteria and availability as well as improved technology have seen a decline in the use of cadaveric materials in training, teaching and demonstrating environments.

In 2012, the International Federation of Associations of Anatomists (IFAA) made a recommendation that only cadavers acquired through voluntary donation be used for teaching, training and research. Considering a large number of countries rely on unclaimed bodies for these purposes, as well as the high cost of acquiring and storing cadavers, the development of effective teaching and learning alternatives are an important emerging industry. Anatomy models and virtual dissection software have supplemented and, in some instances, replaced cadavers and wet specimens in gross anatomy teaching labs all over the world. One study has found that anatomy models are the most effective gross anatomy teaching tool compared with virtual dissection software and even cadaveric material pro-section as stand-alone learning aids.

With the advent and advancement of 3-D printing (3Dp) or Additive Manufacturing (AM) technology, 3D printed models are being used to teach, plan and practice surgical procedures as well as provide better patient education. Unlike other manufacturing techniques, AM can utilise Magnetic Resonance Imaging (MRI) and Computed Tomography (CT) in the design process and/or CAD engineering programmes can be utilised to create anatomical shapes and test motional rotation and forces which results in detailed and anatomically correct replication of the anatomy, and in some cases, the production of functioning anatomical models. It has also led to the advent of tailored patient 3D models for surgical planning and rehearsal which decreases patient risk of iatrogenic injury, reduces surgical times and improves surgical outcomes for patients. In addition to tailored anatomical models, 3Dp enables manufacturers to produce custom pathologies within anatomy models including aneurysms, tumours and a variety of fracture patterns. These can be custom designed and manufactured to the client's specifications and needs.

A rapidly growing demand for surgical training models has emerged within the field of orthopaedic surgery, particularly for lower limb and upper limb fracture repair surgeries. Fracture patterns are diverse and occur on multiple sites. Depending on the location and severity of the fracture, unique surgical approaches are often required, thus the demand for anatomically correct models containing a variety of pathologies. Additionally, with the advancement of orthopaedic technologies, surgeons are frequently required to train on new technologies and products. The ability for surgeons to train on models up-skills surgeons without the need for them to learn and practice on live patients while still following the traditional tenet of surgical training, ‘see one, do one, teach one’.

In addition to 3D models producing better anatomy teaching outcomes, they can be easily obtained, transported, stored and reused. However, concerning the reuse of 3D models for teaching, this is not always the case for 3D models used for surgical planning or surgical teaching and practice. Once the models have been used, they are disposed of and need to be replaced. This is a very costly and wasteful exercise, particularly with larger anatomical models such as the lower limb. It also makes the routine use of large anatomically correct 3D models financially inaccessible to most healthcare and educational institutions. Not only does the expensive, disposable nature of the products limit the accessibility of invaluable, life-saving surgical practice aids, it also has an undesirable environmental impact.

Accordingly, there exists a need for improved surgical training model that reduces or at least ameliorates some of the problems of the prior art.

### BRIEF SUMMARY

In a first aspect there is provided a surgical training model comprising a plurality of adjacent cassettes attached together to simulate a spine, the cassettes comprising spacer cassettes each being removable and replaceable with one or more anatomy cassette(s) that simulates an anatomy and or pathology in the spine, wherein adjacent cassettes can be: attached cassettes with a join, or unattached cassettes when not joined, the join between attached cassettes being substantially fixed so that, other than allowing for unattached cassettes, the attached cassettes do not move relative to one another about said join.

Herein provided is a surgical training model comprising a plurality of removable spacer cassettes that when arranged together simulate a spine, each spacer cassette being removable and replaceable with an anatomy cassette that simulates anatomy and or pathology in the spine.

The interchangeable parts of the surgical training model will be referred to herein as “cassettes”. Cassettes containing detailed anatomy and or pathologies will be referred to herein as “anatomy cassettes”, and the cassettes optionally without detailed anatomy and without pathologies will be referred to herein as “spacer cassettes”.

Also described herein is a surgical training model comprising a plurality of removable spacer cassettes that when arranged together simulate a limb or joint, each spacer cassette being removable and replaceable with an anatomy cassette that simulates anatomy and or pathology in the limb or joint. The limb that is simulated can be a lower limb. The limb that is simulated can be an upper limb. In an embodiment, the limb is a leg. In an embodiment, the limb is selected from one or more of a leg, a hip, an arm or a shoulder.

The limb or joint or spine can be an animal limb or joint or spine. The limb or joint or spine can be a human limb or joint or spine. In the following description a human limb or spine is referred to since the surgeons training on the model are typically human surgeons that will operate on other humans. However, there is no reason that the disclosure described herein could not be applicable to veterinary surgeons who operate on animals.

The surgical training model can be a lightweight 3D printed replica of the human lower limb consisting of multiple lightweight spacer cassettes on multiple positions on the leg. The surgical training model can be a lightweight 3D printed replica of the human spine consisting of multiple lightweight spacer cassettes on multiple positions on the spine. These cassettes can be removed and replaced with anatomy cassettes of various sizes containing various anatomies or pathologies. When the anatomy cassettes have been used and removed, the lightweight spacer cassettes can be returned.

A few simulator training models with replaceable parts are available to purchase, i.e. parts that can be replaced after use. These include breast examination, catheterization, arthroscopy, episiotomy and vasectomy simulators. At the time of writing and to the best of our knowledge, no anatomy or training model on the market has been designing with interchangeable parts, i.e., parts containing different anatomies or pathologies on the same model. Existing training or simulator models are made and sold, but only cater for the practice of one procedure, i.e., each procedure simulation requires a separate model.

At the time of writing and to the best of our knowledge, no 3Dp anatomy model manufacturers produce models with either replaceable or interchangeable parts. Artificial models are typically large, heavy, and costly to produce. Once the model has been used, it is disposed of. At the time of writing and to the best of our knowledge, a solution to reduce the cost and waste of surgical training models does not exist.

The present surgical training model may, in embodiments, increase the versatility of the 3D training model, may reduce costs and in embodiments minimises the environmental impact by decreasing the volume of disposable parts. The reduction in production costs and the versatility provided by the model may make the surgical model more affordable and thus more accessible to healthcare industries, healthcare providers, surgeons, educators and students.

The surgical training model can be light weight. By light weight it is meant that the model can be readily carried by one person. Because the surgical training model is lightweight, in embodiments, it is easier to transport and store, and less expensive to ship than a full surgical model would be. The surgical training model of a limb or joint once fully assembled can weigh less than about 26, 20, 14 or 12 kg. The spine training model may weigh more due to the abdomen cavity, the size and or the density of the materials used. Each cassette in the model can weigh at most about 5 kg, 4 kg, 3 kg, 2 kg, 1 kg or 500 g. A larger surgical training model of e.g. the full lower leg will weigh more than a smaller surgical training model of e.g. the human arm.

The surgical model can be 3D printed using advanced 3D printing techniques. The surgical model can be made using a combination of manufacturing technologies. The model is not necessarily made wholly using 3D printing techniques. The model can be prepared in standard sizes. The standard sizes can be based on a typical limb or joint or spine size using average dimensions sourced from data gathered from a human population. For example, the average human arm is 25 inches, with male arms tending to be longer and heavier than female arms due to increased bone size and larger muscles. Every human is different. With this in mind, there can be various standard sizes of the limbs and joints and spines prepared such as small, medium, large, X-large. The small limb may have a length of about 15 inches, the medium limb may have a length of about 18 inches, the large limb may have a length of about 20 inches and so on. A small spine may have a length of about 20 inches and a large spine may have a length of about 28 inches. The spine is divided into different regions, including the cervical, thoracic, lumbar, sacral, and coccygeal regions, and each region has a different length and number of vertebrae. The standard sizes can be varied according to design preferences and customer requirements as would be understood by the person skilled in the technical area. The model can be adjusted to accommodate any race or gender. In an embodiment, a real size human spine is created and then reduced in size by 70 to 85% to reduce the amount of materials required during manufacturing. Alternatively, the limb or joint or spine can be 3D printed or otherwise manufactured as a tailored model based on data taken from a subject patient. A tailored anatomical model may be desired where the model is intended to be used in training for a specific surgical procedure on the subject patient.

The cassettes can be self-supporting once connected to one another. The cassettes can be arranged adjacent one another to complete the limb or joint or spine. Each cassette can be coloured and shaped to simulate the inside and or outside of a human body. The cassette pieces can appear as a puzzle that have to be fitted together in the correct order so as to provide the overall realistic appearance of the limb or joint once assembled.

A spine typically comprises of 33 vertebrae. The cervical region is located at the top of the spine, and it consists of seven vertebrae labelled as C1 to C7. The thoracic region is located in the middle of the spine, and it consists of 12 vertebrae labelled as T1 to T12. The lumbar region is located at the bottom of the spine, just above the sacrum, and it consists of five vertebrae labelled as L1 to L5. The sacral region is located at the base of the spine, and it consists of five fused vertebrae that form the sacrum. The coccygeal region is located at the very bottom of the spine, and it consists of four fused vertebrae that form the coccyx or tailbone. There can be individual variations in the number of vertebrae in each region. For example, some people may have an extra vertebra in the cervical or lumbar region, or the sacrum and coccyx may fuse together to form a single bone.

The model comprises a base. The base can comprise a simulated abdomen. The abdomen can be formed for a material that provides a realistic shape and feel of the body and skin of a patient. In an embodiment, the abdomen is formed from silicone, or rubber or latex or similar material. The abdomen can be associated with a head and thorax. Arms can be provided associated with shoulders of the abdomen. Hips and buttocks can be provided associated with the abdomen. In an embodiment, an entire human form is provided including the abdomen.

The abdomen can have a front and a back. The back can comprise a cavity therein for receiving the spine cassettes. The cavity can comprise a channel having a bottom wall and side walls. The cavity can be sized to accommodate each of the cassettes by tight interference fit.

The spacer cassettes can be arranged to provide a complete looking limb or joint with simulation of the outside shape of the limb. The spacer cassettes for the spine can comprise a realistic spine structure including vertebrae and associated soft tissue. There can be about 3, 4, 5 or 6 spine cassettes along the length of the base.

The anatomy cassettes are more detailed and can replace a spacer cassette. In limbs and joints, the anatomy cassettes may appear like the inside of the human body with muscle fibres and arteries/veins, ligaments and bone as if a slice had been taken out of the limb or joint and replicated. With this in mind, the spacer cassettes for limbs and joints are not necessarily 3D printed since they need only provide the underlying limb or joint structure for supporting the anatomy cassette. The anatomy cassettes for limbs and joints are optionally 3D printed because of the level of detail and realism required during any surgical training procedures undertaken on the model. In the spine model, the anatomy cassettes can each comprise one or more vertebrae. There can be in the range of 1 to about 33 vertebrae in an anatomy cassette. Each of the anatomy cassettes appears like the inside of the human body with muscle fibres and arteries/veins, ligaments and vertebral bone. The anatomy cassette for the spine can simulate at least one of the cervical, thoracic, lumbar, sacral, and coccygeal regions. The anatomy cassette can comprise all of the vertebrae or all of the vertebrae in a region. The anatomy cassette can simulate some of the vertebrae in each region (not all of the vertebrae in that region). In an embodiment, the anatomy cassette spans vertebrae from adjacent regions, e.g. the cervical and thoracic regions.

To form the spine anatomy cassette the vertebrae required can be 3D printed using suitable materials that simulate bone. The parts that can be 3D printed include (but are not limited to) the spinal cord, the vertebral disk, the spinous processes, the vertebral foramen, nerves and ligaments. Once the spine parts have been 3D printed, soft tissues can be located around the 3D printed article. The soft tissues can include veins, arteries, internal muscles, glands, fascia. To form the cassette, the structure comprising the 3D printed materials and the soft tissues once assembled can be encased in a muscle mould. The resultant cassette is substantially rectangular cuboidal and is sized to slide into the channel of the cavity of the base. In an embodiment, the cassette once formed will be located in the posterior of the abdomen where the spine segments are those from e.g. the lumbar region. The cassette will be inserted into the channel of the cavity of the base in the thoracic region where the spine segments are those from thoracic region and so on. In an embodiment, a single cassette comprises occiput to T3; T4 to T12; L1 to sacrum or any combination of the spine and soft tissue from occiput to sacrum that fits with the base. A cover of skin can be applied over the top of the cavity opening, over the cassettes, so as to provide the look and feel of a realistic body prior to surgery. The cassette can be subject to an operation. The base can be reused once the cassette has been used.

The muscle mould can be formed by providing a reverse mould of the spine into which the spine is encased.

The cassettes can each be marked e.g. by numbers to assist in their assembly together with one another. The markings on the cassettes can be sequential so as to make it clear in which order the cassettes should be joined with one another. The markings can also assist the user to determine which way up an anatomy cassette should be inserted relative to the spacer cassettes provided.

Once the cassettes are located into position relative to one another, in embodiments, the limb or joint can be moved about any joint(s) present so as to simulate natural limb movement. The limb can be provided together with a joint. Each limb might have multiple joints e.g., lower limb has hip, knee and or ankle. The spinal segments are able to move substantially in the same way as a natural spine will move. The vertebrae in the spine are attached to each other by a combination of joints, ligaments, and muscles. Each vertebra has a bony protrusion called the spinous process. Between the spinous processes of adjacent vertebrae are flexible joints called facet joints, which allow for movement and flexibility of the spine. The vertebra in the cassettes are manufactured with facet joints which allow for some free movement between each vertebra. Each vertebra has two facet joints, one on each side. The joints are located between the superior articular process of the lower vertebra and the inferior articular process of the upper vertebra. In addition to the facet joints, the vertebrae are also connected by simulated ligaments that run along the front and back of the spine. The ligaments provide stability and support to the adjacent vertebra. The artificial muscle surrounding the vertebra also plays a role in keeping each vertebrae attached and aligned.

Each spacer cassette can be securely attached to an adjacent cassette once in position. The removable attachment of spacer cassettes to one another can be by complementary attachment locations. The complementary attachment locations can be one or more of clips, magnets, adhesive or other. In an embodiment in which the model is a limb or joint, each spacer cassette has an attachment location at each of its ends. The attachment location can be a strong, rigid plate on either end of the cassette that can comprise protrusions which can be inserted into a vacant position on a strong, rigid plate of an adjacent cassette. The protrusions and vacant positions can be dove-tail joints or similar engaging fasteners which holds each cassette in the limb or joint into position relative to one another. The rigid plate can be formed integrally with the cassette. The rigid plate can be formed separably to the cassette and joined with it afterwards to provide an integral piece. In the spine model, since each of the cassettes is located in the cavity which squeezes the cassettes when in position, there does not need to be an attachment location other than tight interference fit and optionally small clips and or magnets. The spine cassettes can be aligned in the channel and will then remain in position during operation.

Each spacer cassette is removable independently of the other cassettes. Each spacer cassette can be replaceable by an anatomy cassette. The anatomy cassettes can each represent a particular anatomy or a pathology. Replacement and interchangeable cassettes can be customised or tailored and made to order according to the needs of the client without the need for additional parts. The present surgical model, in embodiments, allows anatomies including bone structure, ligament structures, any unusual healing, shaping or congenital defects to be inserted into the model without the need for a new model to be produced. The present surgical model, in embodiments, allows pathologies including multiple fracture patterns, or multiple spinal injuries, to be inserted at multiple locations at the appropriate placement on the model without the need for an entirely new model to be produced for every fracture location or other pathology.

The anatomy cassette can simulate a pathology, disease, deformity, dislocation, fracture or injury of any kind including a lodged foreign body, or any alignment that can cause limb/joint or back pain. The pathologies can include any maladaptation of the limb or joint that requires a surgical procedure to correct. The pathology can be selected from one or more of a fracture, an aneurysm, a tumour, and a lodged foreign body. The pathologies can be selected from herniated disc, spinal stenosis, scoliosis, degenerative disc disease or sciatica. In some embodiments, a spinal cord injury can be simulated. Before the advent of sterile surgical conditions and techniques, physicians stabilised fractures or other injury using external casts and splints. Now, internal fixation using implants such as plates, screws, and wires is common practice. In limbs, each fracture type and classification requires its own unique approach. Fracture locations in the lower limbs include distal femur, femoral head, femoral shaft, proximal tibia, distal tibia and tibial shaft, as well as different locations on the fibula, or a combination of fracture sites. Fracture locations in the upper limbs include humerus, radius and ulna fractures or a combination of fracture sites. Each aneurysm type and classification requires its own unique approach. Aneurysm locations can be at any location along the limb where arteries and veins travel. Each tumour type and classification requires its own unique approach. Tumour locations can be at any location in the limb where there is tissue. Foreign bodies can become lodged in the limb for any reason. Foreign bodies include bullets and nails that sometimes become lodged in the limb by accident. In addition to pathologies, as noted above, various anatomies can be simulated be they commonplace or unusual.

Cassettes can be developed for revision surgery, where an original surgical operations needs to reworked due to complication or wear and tear. A number of the same cassette can be produced for more than one approach to the surgery to be tried and tested. Cassettes can also be developed to provide training for new tools or implants that are constantly evolving.

The anatomy cassette can fit into the location of the removed spacer cassette and be firmly located into position. In an embodiment, the anatomy cassette can be attached to the spacer cassettes using the same attachment location means as described above. Optionally, a different attachment is provided so long as it is engageable with the spacer cassette in some way that allows it to co-exist with the spacer cassette during use. Anatomy cassettes can be inserted at the joints of the limb (elbow, wrist, ankle, knee), at various positions along the shafts of the limb bones, at the proximal and distal ends of each of the limb bones or a combination of cassettes can be inserted at different locations at the same time. Anatomy cassettes can be inserted along the spinal column. The anatomy cassette and remaining spacer cassettes do not move relative to one another once in position so that any surgical procedure performed on the simulated model is not hampered by unrealistic movement of sections or parts. However, the anatomy cassette, once inserted, may allow the limb or joint or spine that it forms to have a full range of normal motion representing human limb or joint or back motion.

In an embodiment a large anatomy cassette can be manufactured as one cassette piece to provide a larger surgical dissection region. The larger single anatomy cassette may replace two or more of the spacer cassettes in any combination. In an embodiment, the large anatomy cassette is not associated with any spacer cassettes. The large anatomy cassette can comprise the whole head thoracic and abdomen region, or just the abdomen region. The large anatomy cassette can comprise the 3D printed spine, associated with soft tissue materials and encased in muscle mould as described above. Other components of anatomy can be added to the 3D printed spine with the soft tissues, such as kidneys, liver, stomach. Casting the structures into the muscle mould can be undertaken by 3D printing muscle which is layered around the structures to form the final product. The structures can be encased in the muscle mould by creating a reverse mould of the structures in two half parts, and then bringing those parts together around the structures to form the final product. Alternatively, a muscle mould is precast into a sleeve shape and the structures including the spine, soft tissues, organs, slide into the sleeve and conform to the inner surfaces thereof. The final product can be wrapped in layers of fat, fascia and skin.

Once the anatomy cassette has been used (i.e. dissected, operated upon, otherwise irreversibly destroyed), it can be removed and stored or disposed of. If applicable, a spacer cassette can be inserted back in its place or it can be replaced by another anatomy cassette for another use. The model comprising a plurality of spacer cassettes and anatomy cassettes is infinitely reusable as spacer cassettes and anatomy cassettes are switched into and out of position as required. The model without spacer cassettes is dully recyclable.

An advantage of the full base model in which there are no spacer cassettes is that surgery can be performed from the anterior and posterior of the model. Examples of surgeries include vertebroplasty and kyphoplasty, spinal laminectomy/spinal decompression, discectomy, foraminotomy, nucleoplasty, disk decompression, spinal fusion, artificial disk replacement.

Also provided is a system providing training of a surgical procedure, the system comprising
obtaining details optionally from a patient regarding the dimensions of their limb or joint and the location(s) of one or more anatomies or pathologies in the limb or joint;
providing a 3D printed surgical training model comprising a plurality of spacer cassettes as herein described based on the patient's dimensions or other standard dimensions,
locating anatomy cassette(s) in the 3D printed surgical training model at the location(s) of the one or more anatomies or pathologies by replacing spacer cassette(s) with the anatomy cassette(s).

Also provided is a system providing training of a surgical procedure, the system comprising
obtaining details optionally from a patient regarding one or more anatomies or pathologies in a spine;
providing a surgical training model comprising a plurality of spacer cassettes as herein described,
locating anatomy cassette(s) in the surgical training model at the location(s) of the one or more anatomies or pathologies by replacing spacer cassette(s) with the anatomy cassette(s).

In an embodiment, a surgical training procedure is related to an unusual knee structure. The details about this knee structure may originate from an actual patient, but the details for creation of the present surgical model are simulated using off the shelf software that can generate a limb of an average person. A plurality of spacer cassettes can be manufactured to provide a limb. The limb can be made up from a plurality of spacer cassettes but once they are all fitted together, it looks like one whole limb. The unusual knee anatomy can be 3D printed as a knee joint cassette. The spacer cassette of the limb that is at the location of the knee joint can be removed. The anatomy cassette 3D printed with the knee anomaly can be inserted into the limb. More than one limb that is identical to the one described in this paragraph can be prepared. This means that multiple surgical models could be provided for a surgical training day or an exam in the knowledge that each limb is the same as the other so no one person is disadvantaged or has an advantage.

In another embodiment, a surgical training procedure is related to a tumour in a shoulder joint. The details about this tumour may originate from an actual patient, but the details for creation of the present surgical model can be simulated using off the shelf software that can generate a shoulder joint of an average person. A plurality of spacer cassettes can be manufactured to provide a joint attached to the limb. The joint and limb can be made up from a plurality of spacer cassettes but once they are all fitted together, it looks like one whole shoulder and arm limb. The pathology can be 3D printed as a shoulder joint cassette. The spacer cassette of that is at the location of the shoulder joint can be removed. The anatomy cassette 3D printed with the shoulder anomaly can be inserted into the model. More than one model that is identical to the one described in this paragraph can be prepared. This means that multiple surgical models could be provided for a surgical training day or an exam in the knowledge that each limb is the same as the other so no one person is disadvantaged or has an advantage.

In another embodiment, a surgical training procedure is related to a herniated vertebra in a spine. The details about this herniation may originate from an actual patient, but the details for creation of the present surgical model can be simulated using off the shelf software that can generate a spine of an average person. A plurality of spacer cassettes can be manufactured to provide the spine. The pathology can be 3D printed as an anatomy cassette of e.g. vertebrae L4. The spacer cassette of that is at the location of L4 can be removed. The anatomy cassette 3D printed with the herniation anomaly can be inserted into the model. More than one model that is identical to the one described in this paragraph can be prepared. This means that multiple surgical models could be provided for a surgical training day or an exam in the knowledge that each spine is the same as the other so no one person is disadvantaged or has an advantage.

An operation can be performed on the model. The operation can be by open cut, keyhole. The operation can be performed by a human. The operation can be performed by a robot.

Furthermore, once each of the models described above has been used, the anatomy cassette of interest can be removed. The spacer cassette can be placed back into the model. The model can then be stored until it is required for use again. The next time the model is used, it may have a different anatomy cassette simulating a different anatomy or pathology.

### BRIEF DESCRIPTION OF THE FIGURES

Embodiments of the disclosure will now be described with reference to the accompanying drawings which are not drawn to scale and which are exemplary only and in which:

FIG. 1A and FIG. 1 B are lateral perspective views of a surgical training model in an embodiment in which the model is of a lower limb including the knee.

FIGS. 2A, 2B and 2C are a lateral schematic view of the surgical training model of FIG. 1 showing the possible locations of spacer cassettes and anatomy cassettes.

FIGS. 3A, 3B and 3C are anterior perspective views showing some of the cassettes of the model of FIG. 2 in exploded view.

FIGS. 4A and 4B are a close-up views of the joint between two cassettes in FIG. 3 showing an embodiment of an attachment mechanism.

FIG. 5 is an alternative embodiment in which the cassettes are mounted on a base.

FIGS. 6A and 6B are alternative embodiment to the one shown in FIG. 4 in which a different attachment mechanism is shown.

FIGS. 7A and 7B are side view perspective views of a surgical training model in an embodiment in which the model is of an upper limb including the elbow.

FIG. 8 shows a plan view of different cassette pieces that could be prepared.

FIG. 9 shows a plan view of how cassette pieces can be fit together to form a limb.

FIG. 10 shows a lower limb with an anatomy cassette at the knee joint. The limb is movable about a pivot point.

FIG. 11 is a different view of the limb of FIG. 10.

FIG. 12 is a perspective view of an anatomy cassette which in this embodiment is a knee.

FIG. 13 is a bottom view of the cassette of FIG. 12.

FIG. 14 is a first end view of the cassette of FIG. 12.

FIG. 15 is a second end view of the cassette of FIG. 12.

FIG. 16 is a top view of the cassette of FIG. 12.

FIG. 17 is a lateral view of the cassette of FIG. 12 with the knee joint bent.

FIGS. 18 and 19 show a base model of the head and thorax and abdomen. A cross section of the model is provided at FIG. 19.

FIGS. 20 and 21 show a base model with a cavity formed therein. A cross section of the cavity is show at FIG. 21 with a cassette being inserted.

FIG. 22 is an illustration of lumbar region with L1 to sacrum prior to encasing in muscle mould.

FIGS. 23 and 24 shows the structures of FIG. 22 encased in muscle mould.

FIGS. 25 and 26 show the model in use during operation.

### DETAILED DESCRIPTION

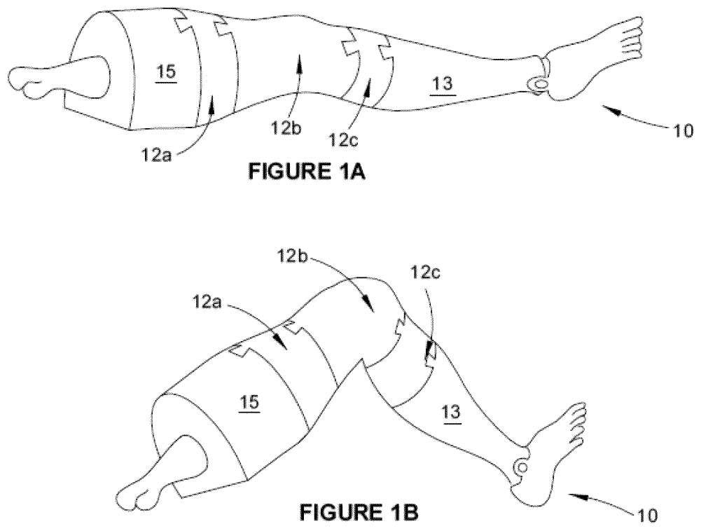

FIG. 1 shows an embodiment of a surgical training model 10 comprising a plurality of removable spacer cassettes 12 that when arranged together simulate a human limb which in this embodiment is a leg. Each spacer cassette 12 is removable and replaceable with an anatomy cassette 14 that simulates a pathology in the human limb. Each spacer cassette can have the appearance of solid external skin.

In FIG. 1, there is shown for exemplary purposes three spacer cassettes 12a, 12b, 12c. There is also shown the lowermost cassette 13 which is the lower part of the leg including a foot. The uppermost cassette 15 is the top part of the model and has a bone showing in the location at which the bone would protrude from a leg. The bone can be modified into a ball joint for use as described further below. The lowermost cassette 13 and the uppermost cassette 15 each have an attachment location at one end to allow the joining of cassettes in series.

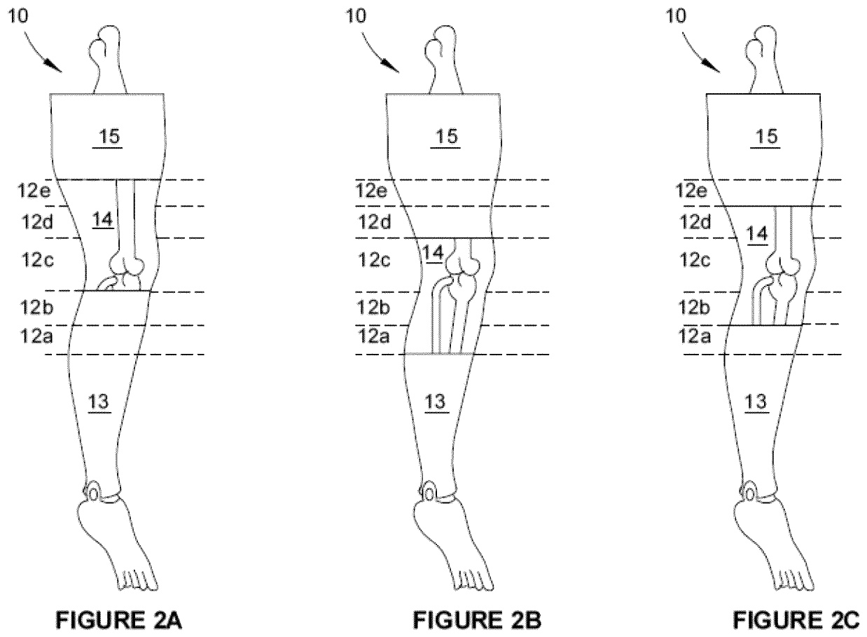

The surgical training model 10 of the embodiment of FIG. 2 is a lightweight 3D printed replica of a human lower limb consisting of multiple lightweight spacer cassettes 12 on multiple positions on the leg. The arrangement in FIG. 2 is similar to the embodiment of FIG. 1, although now there are locations for five spacer cassettes 12a to 12e. These cassettes 12a to 12e can be removed and replaced with anatomy cassettes 14 of various sizes containing various pathologies. In embodiments, cassettes 13 and 15 can also be spacer cassettes.

In FIG. 2A, spacer cassettes 12c, 12d and 12e have been removed and replaced with anatomy cassette 14. In FIG. 2B, spacer cassettes 12a, 12b and 12c have been removed and replaced with anatomy cassette 14. In FIG. 2C, spacer cassettes 12b, 12c and 12d have been removed and replaced with anatomy cassette 14.

Each of the anatomy cassettes 14 has a different location of pathology or anatomical issue of interest. The choice of location of the anatomy cassette can depend on where the pathology is on an actual patient or where a simulated anatomy or pathology is desirable. For example, a patient with a pathology or anatomical issue of interest relating to the femur could use the anatomy cassette 14 of FIG. 2A. A patient with a pathology or anatomical issue of interest relating to the tibia could use the anatomy cassette 14 of FIG. 2B. A patient with a pathology or anatomical issue of interest relating to the knee could use the anatomy cassette 14 of e.g. FIG. 2C. For example, a surgeon wanting to train a student on a pathology or anatomical feature of interest can also design his own anatomy cassette for insertion into the relevant place into the model.

The health practitioner could work on the anatomy cassette 14 by e.g. undertaking a procedure. The practice on the cassette 14 might allow the practitioner to become familiar with the way in which to approach the pathology. Alternatively, or in addition, it might allow them to try various approaches to see what would work best. The practice on the cassette 14 might allow them to show another practitioner or train another practitioner on how to work on the particular pathology. When the anatomy cassette 14 has been used, it can be removed and the relevant spacer cassettes 12 can be returned. Alternatively, a new anatomy cassette 14 can be inserted ready for the next procedure.

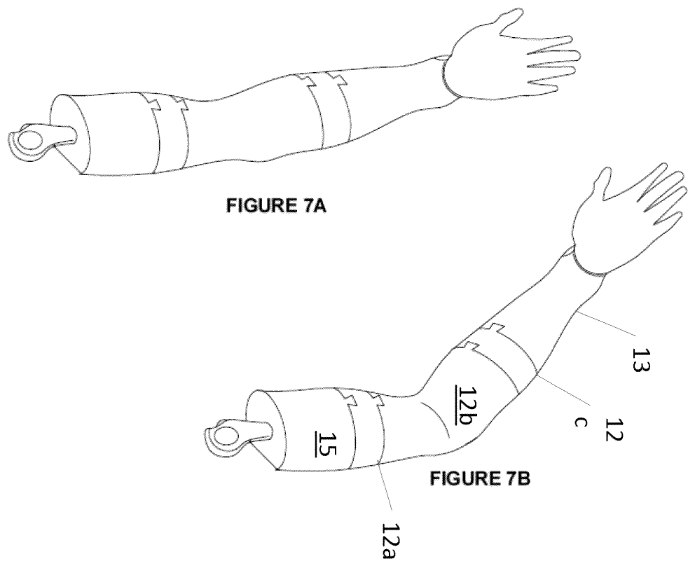

In order to increase the realism of the model 10, the cassettes 12, 13, 14 and 15 of the model can be 3D printed or a combination of manufacturing technologies can be employed. Each cassette can be manufactured according to a required set of dimensions so that the overall limb once assembled is the required size. A small female limb might have cassettes that are relatively smaller in all dimensions when compared to a large male limb. The lower most cassette 13 can include additional features such as a foot (as shown in e.g. FIG. 1) or a hand if the limb is an arm (e.g. FIG. 7). The uppermost cassette 15 can include the hip or shoulder part of the body that the limb would extend from. In some embodiments, a spacer cassette located at the hip or shoulder, wrist or ankle can be replaced by an anatomy cassette. Once the cassettes 12, 13, 14, 15 are located into position relative to one another, in embodiments, the limb 10 can be moved about any joint(s) present so as to simulate natural limb movement. Optionally, each spacer cassette can be coloured/decorated to provide a realistic experience of a removed body part. The surface of the cassette can be plain in colour, white of skin tone.

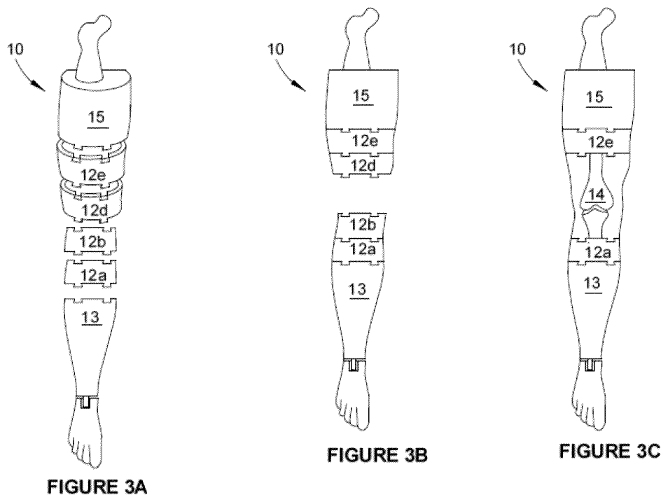

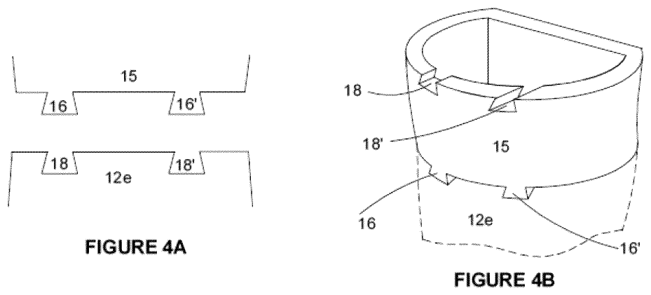

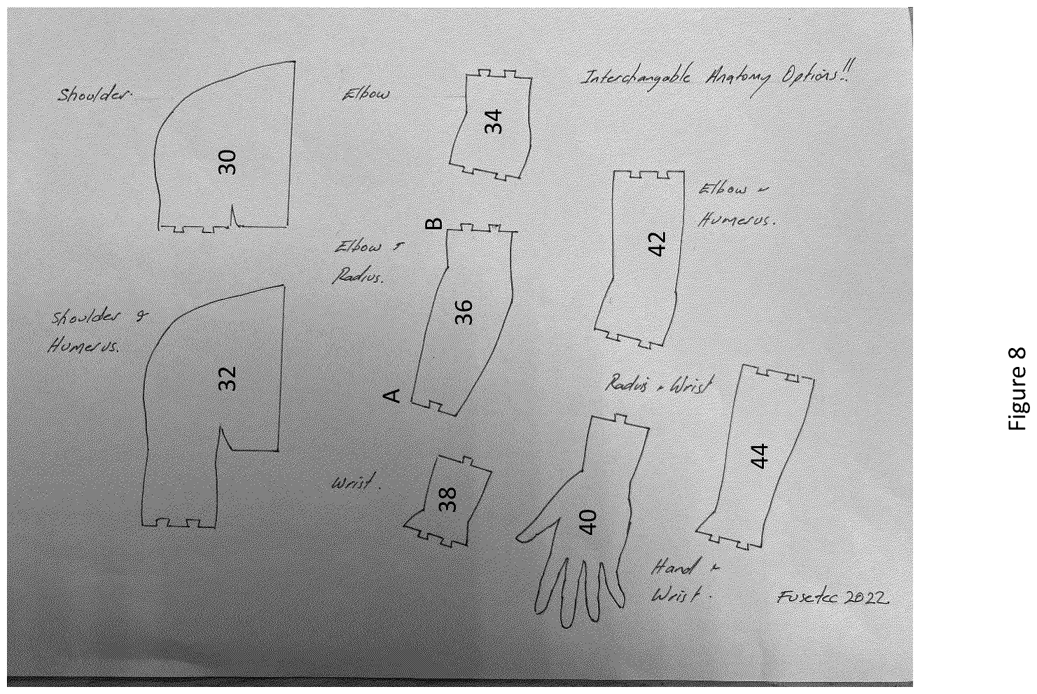

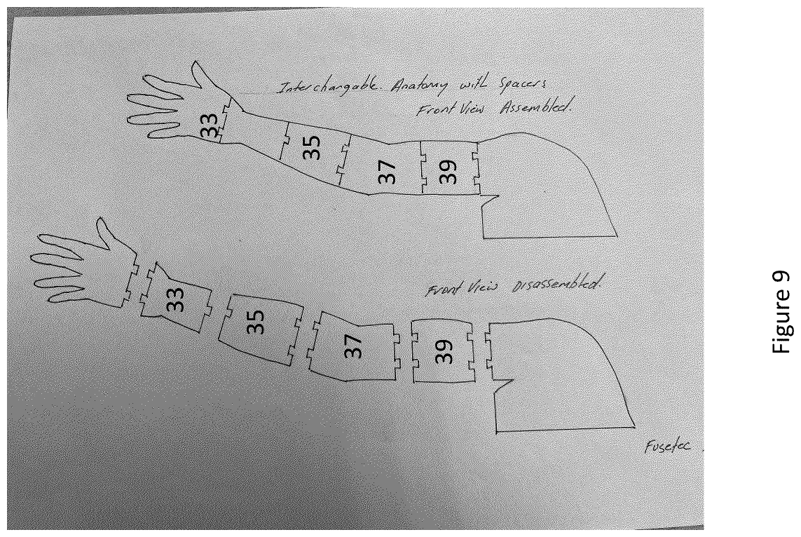

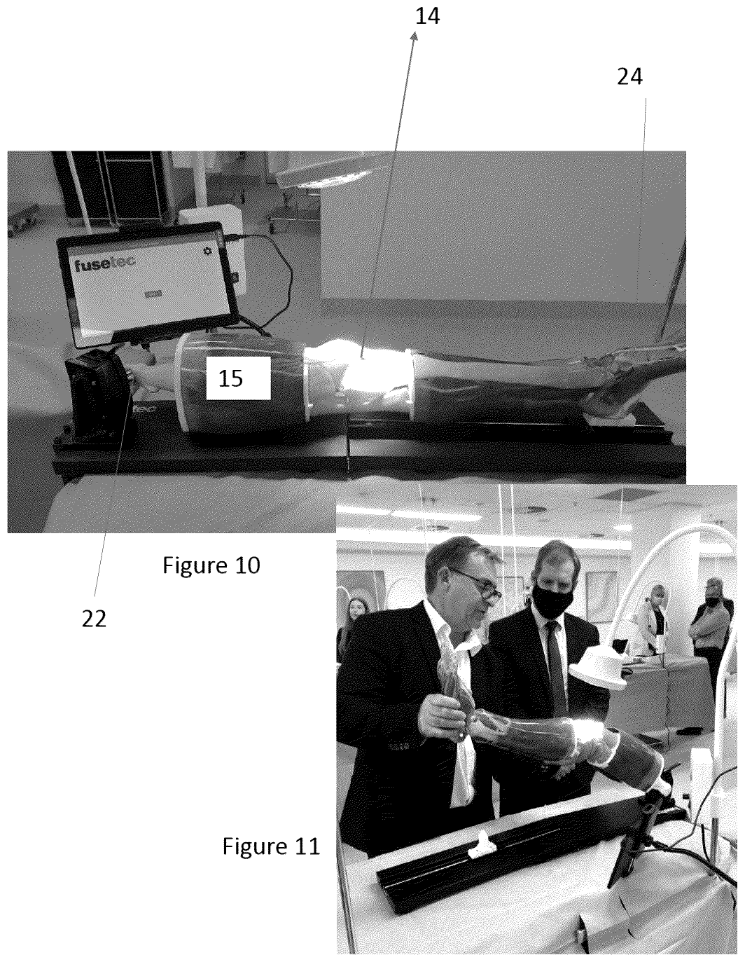

In FIG. 7, there are shown cassettes 12a, 12b, 12c which are functional equivalents to those of the leg of FIG. 1 only now they are forming an arm. There is also shown the lowermost cassette 13 which is the lower part of the arm including a hand. The uppermost cassette 15 is the top part of the model arm and has a bone showing in the location at which the bone would protrude from the arm. This bone can be a ball joint for use as described further below in respect of FIG. 10. The lowermost cassette 13 and the uppermost cassette 15 each have an attachment location at one end to allow the joining of cassettes in series. FIGS. 8 and 9 show one option for all the different parts that can be provided to build an upper limb. There can be a shoulder cassette 30, a shoulder plus humerus cassette 32, an elbow cassette 34, an elbow plus radius cassette 36, a wrist cassette 38, an elbow plus humerus cassette 42, radius plus wrist cassette 44 (Also hand 40). Any one of these pieces can replace one or more of the spacer cassettes in FIG. 7 or FIG. 9. For example, spacer cassette 12b of FIG. 7 could be replaced with the elbow plus radius cassette 36. For example, shoulder plus humerus cassette 32 could replace two of the spacer cassettes in FIG. 9. In the embodiments shown in FIG. 3, the cassettes 12, 13, 14, 15 are self-supporting once connected to one another. By self-supporting it is meant that the cassettes do not require any other structural support to hold them together other than the fact that they attach to one another.

In FIG. 3A, the cassettes 15, 12e, 12d, 12b, 12a, 13 are shown in exploded view. (Cassette 12c which would be in the middle of the series around the knee joint has been removed). In FIG. 3B the lower cassettes 13, 12a and 12b have been joined together to form a part of the limb 10. The upper cassettes 15, 12e and 12d have been joined and attached to one another to form the top part of the limb 10. This is shown in close up in FIGS. 4A and 4B where the attachment locations are shown more clearly. To insert anatomy cassette 14, cassettes 12b and 12d are removed and the anatomy cassette 14 is attached in their place. The limb 10 is now ready for use in FIG. 3C.

As can be seen in e.g. FIG. 3, the pieces of the limb 10 may appear as a puzzle that have to be fitted together in the correct order so as to provide the overall realistic appearance of the limb 10. The cassettes 12, 13, 14, 15 can be marked so that the user knows in which order they should be placed. There can also be instructions provided with the model to allow the user to understand how to construct and deconstruct the limb 10.

The attachment of the uppermost cassette 15 to the spacer cassette 12e is shown as two dove-tailed joints 16, 18. This is shown in close up in FIG. 4A. Noted for their resilience to pull apart, these finger-like dovetail joints between two pieces of material can enable a tight interference fit. In order to assemble the joint between two cassette pieces, extensions or tounges 16, 16′ on first end of e.g. cassette 15 are slid into the channels or grooves 18 and 18′ on second end of cassette 12e, respectively. Once in place, the two cassettes 15 and 12e joined first end to second end cannot be pulled apart along the longitudinal axis of the limb 10. It should be understood that there can be more or less than 2 dovetail joints (tongue and groove joints) per cassette pair. Each dovetail joint can be formed integral with its respective cassette during manufacture. Alternatively, the cassette can be formed and then end plates can be attached to either side of the cassette to provide the dove tail parts. If necessary, there can be releasable locking means for preventing or reducing separation of the cassettes once joined.

Each spacer cassette can have a first end A and a second end B as shown in FIG. 8. Some spacer cassettes 12 can have a tongue protrusion at a first end A, and a groove or channel at the second end B. This alternating arrangement will allow for multiple spacer cassettes to connect to one another in series as shown in FIG. 7. Alternatively, some spacer cassettes have tongue like protrusions at both the first end A and the second end B. For example, spacer 34 and 38 and 42 in FIG. 8; and spacers 33 and 37 in FIG. 9. Some spacer cassettes will have grooves at both the first end A and the second end B. For example, spacers 35 and 39 in FIG. 9. Where the spacer cassettes have like type attachment locations at each of the first and second ends A, B, only some of the spacer cassettes may be replaceable.

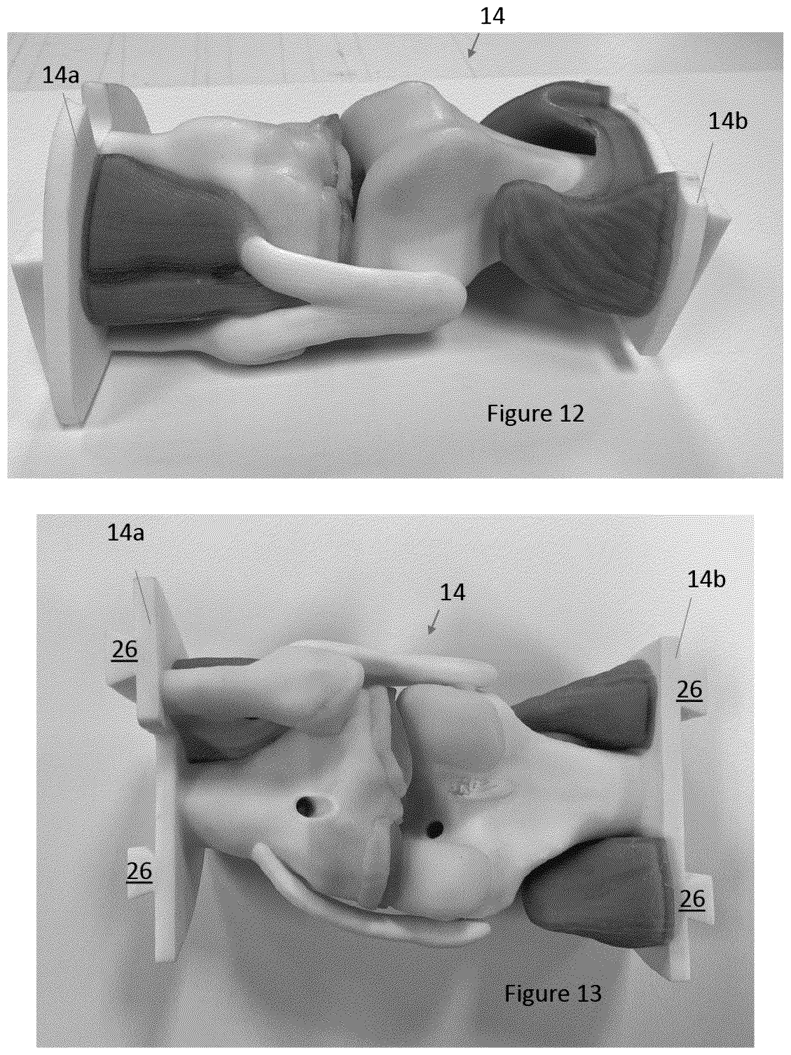

It can be advantageous to have the arrangement shown in FIG. 9 where only some spacer cassettes 33, 37 are replaceable by anatomy cassettes with tongues at each end. Since each replaceable spacer cassette 33, 37 has only tongue protrusions, each anatomy cassette can be provided with only the tongue parts as attachment means (see FIG. 12 onwards). These tongue parts 26 can mate into the grooves of adjacent spacer cassettes 12. Providing an anatomy cassette 14 with grooves can be inconvenient due to the size and shape of the anatomy cassette 14 and that it must be realistic so that cut-out parts may not be accommodatable.

Each spacer cassette 12 is removable independently of the other cassettes 12-15. Each spacer cassette 12 can be replaceable by an anatomy cassette 14. The spacer cassette 12 in e.g. FIG. 4 is shown as hollow, but it should be understood that while any of the cassettes can be hollow, they can also be formed as solid non-hollow pieces. A spacer cassette can be hollow since it simply provides the structure of the model. An anatomy cassette is not hollow because it shows the realistic internal structures of anatomy. Each anatomy cassette 14 can represent a pathology or an anatomical feature of interest.

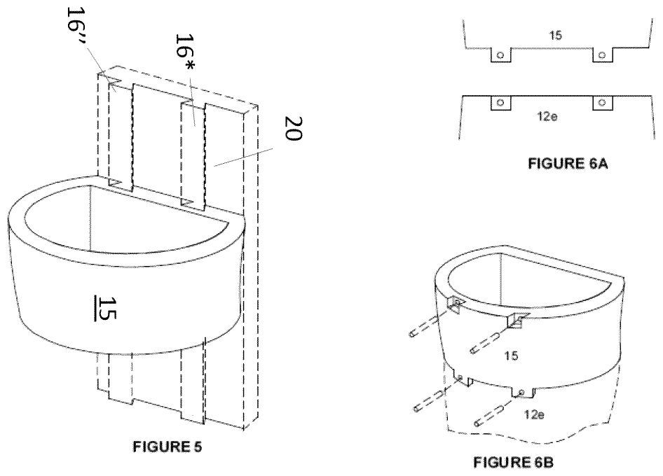

In one embodiment, the model 10 can comprises a base 20 that is used to support the plurality of cassettes 12-15. The base 20 can be a housing, platform, support or container into which the cassettes can be fitted. The base 20 can comprise a shelf onto which the cassettes can be arranged adjacent one another. In FIG. 5, the base 20 is shown as a support 20 having extensions 16″, 16*. The extensions 16″, 16* can be used to connect with the channels 18, 18′ on the cassettes 12-15. Alternative to what is shown the cassette 12-15 can comprise the extensions 16 and the base can comprise the channels 18. Each cassette 12-15 can be slid into position in series to from the limb or joint 10. Optionally, the base is bendable and flexible to allow the limb or joint to move in the same way that a natural limb would move. A disadvantage to a base is that it can inhibit some movement and thus it may not be appropriate for some of the surgical models, particularly joints. A further disadvantage of a base is that in order to replace the spacer cassettes 12 with anatomy cassettes each one has to be removed and then replaced. However, it should be understood that this arrangement is within the spirit and scope of the disclosure.

In an embodiment, the upper part of a limb and lower part of a limb may be mounted e.g. via a ball joint to a metal, wood, plastic or composite base to allow free range of motion from a fixed position around the ball joints rotational axis. As can be seen in FIG. 10 and FIG. 11, the upper spacer 15 can be mounted at location 22. The foot 24 can slide along the base as the joint 14 is moved to provide realistic motion. Optionally, the foot can be lifted just like a real leg. Alternatively, both an upper limb and or a lower limb may be jointed to a manufactured abdomen or thorax to provide an even more realist experience (not shown).

While dovetails are shown in e.g. FIG. 4, it should be understood that the attachment of the cassettes 12-15 to base 20 or to another cassette 12-15 can be by any complementary attachment locations. The complementary attachment locations can be locking pins 22 that pass through a passageway 24 that forms when the cassettes 12-15 are brought into mating connection with one another as shown in e.g. FIGS. 6A and 6B.

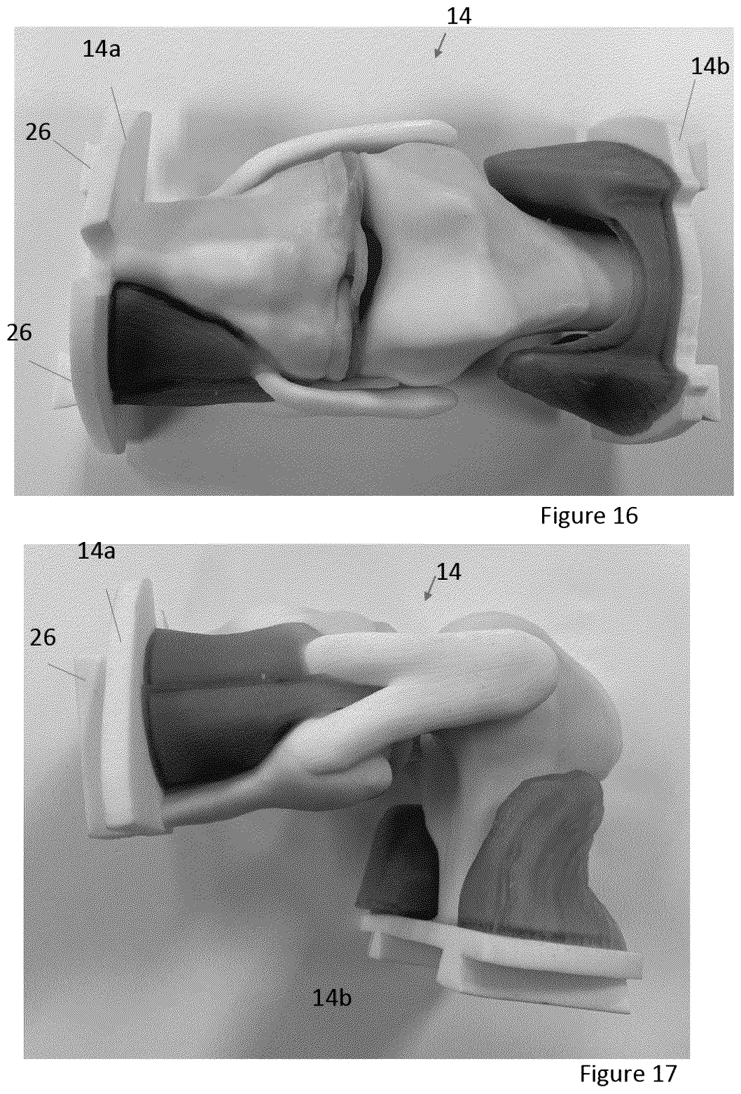

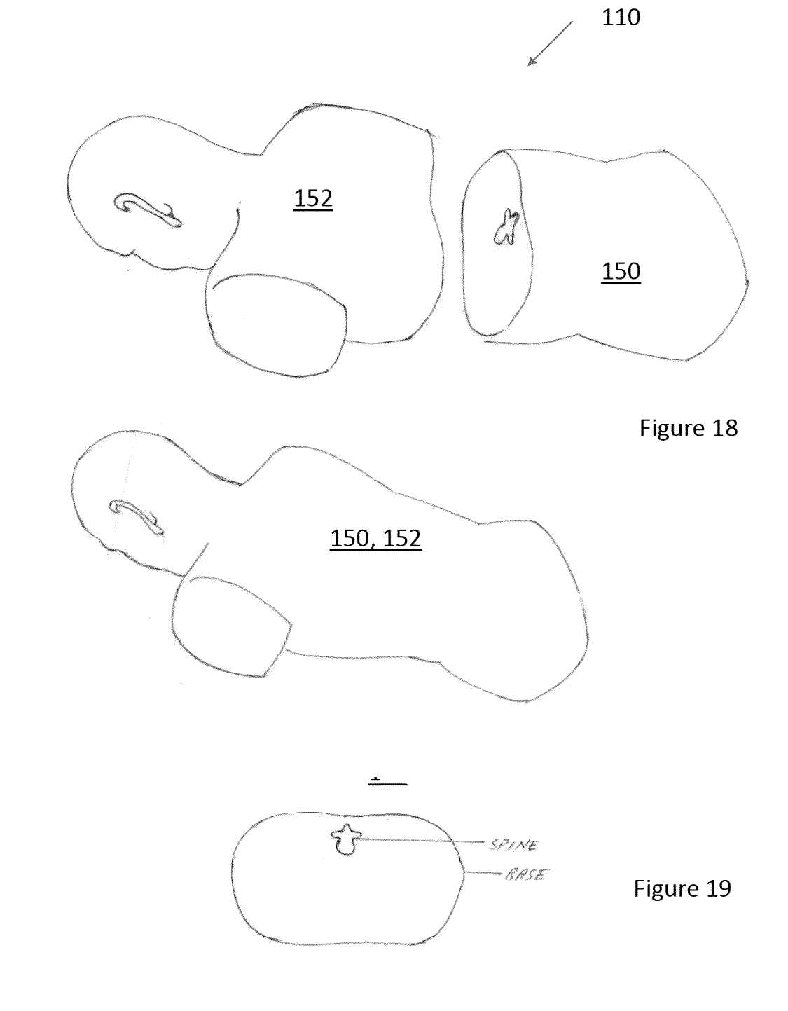

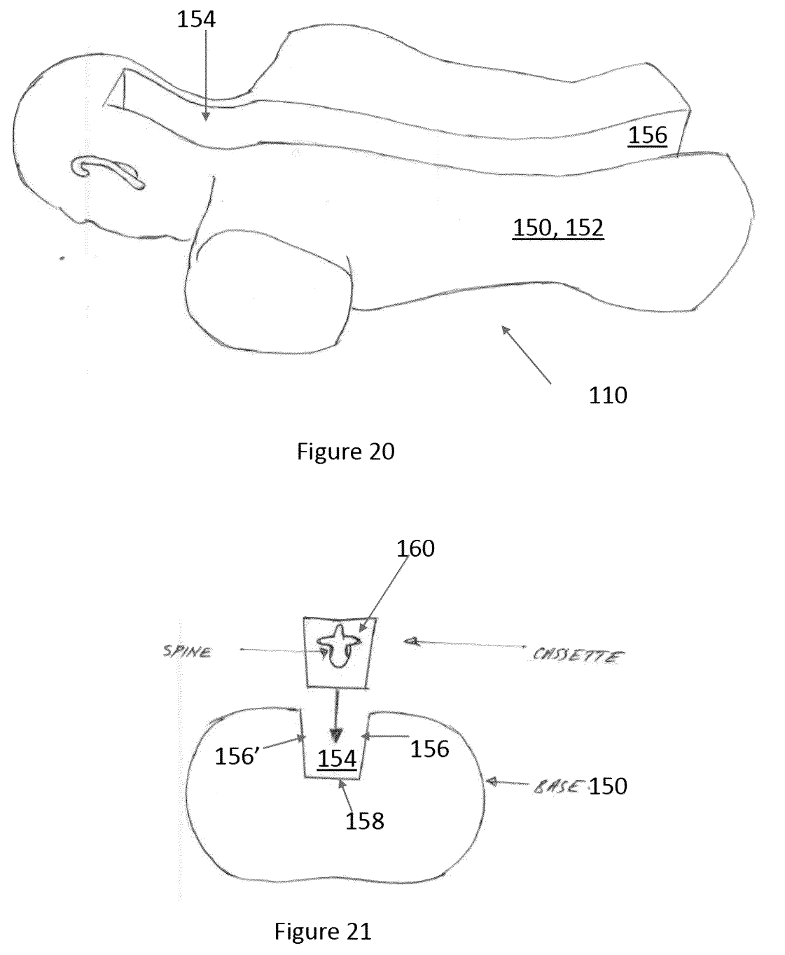

FIGS. 12 to 17 shown an embodiment of an anatomy cassette 14 which is a knee joint. The knee joint bending is shown in FIG. 17. The realistic bone and ligament structures should be clear from the enclosed drawings. Each anatomy cassette 14 is shown having a first end 14a and a second end 14b, the first end 14a and second end 14b each having an attachment means so that the second end 14b of an anatomy cassette 14 is attachable to a first end of an adjacent spacer cassette 12. The attachment means is a tongue 26 which can fit into groove 18 provided on the spacer cassette 12.

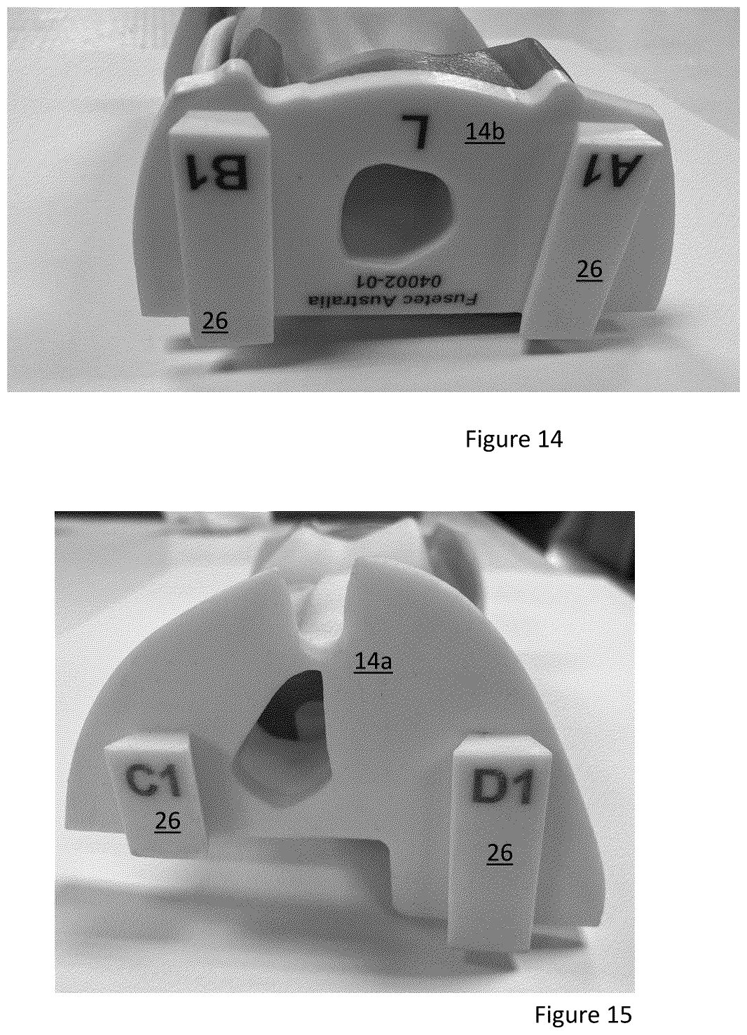

The tongue part 26 of the attachment means can be provided on a plate 14a 14b which can be best seen in FIG. 14 or FIG. 15. As shown in those Figures, there can be at least two tongue parts 26 provided along the entire span of the first end 14a and or the second end 14b.

The model 110 can comprise a simulated abdomen 150. The abdomen 150 can be formed for a material that provides a realistic shape and feel of the body and skin of a patient. The abdomen 150 can be associated with a head and thorax 152. The abdomen can have a front (anterior) and a back (posterior). Both sides can be operable. The back of the abdomen 150, 152 can comprise a cavity 154 therein for receiving the spine 160 cassettes. The spine cassettes can be spacer cassettes (not shown) which are just blocks with no components (or minimal components) inside. The spine cassettes can be anatomy cassettes 160 which have all the spinal structures as discussed for a realistic surgery. The cavity 154 can comprise a channel 154 having a bottom wall 158 and side walls 156, 156′. The cavity 154 can be sized to accommodate each of the cassettes 160 by tight interference fit. In an embodiment, the abdomen (optionally with head and thoracic) is itself an anatomy cassette.

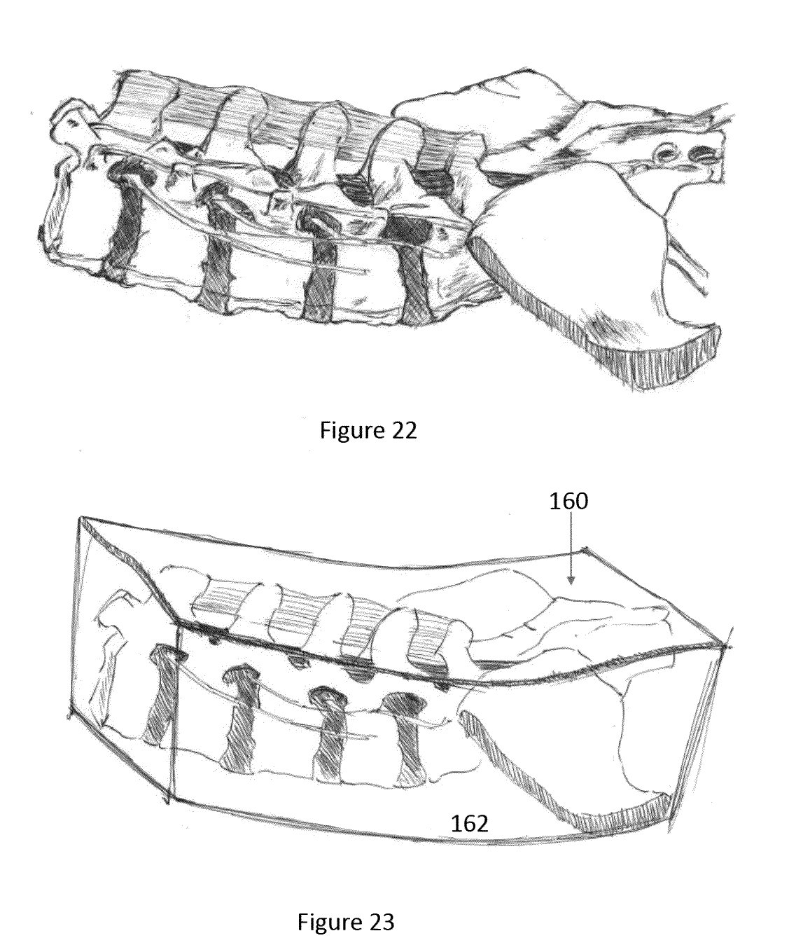

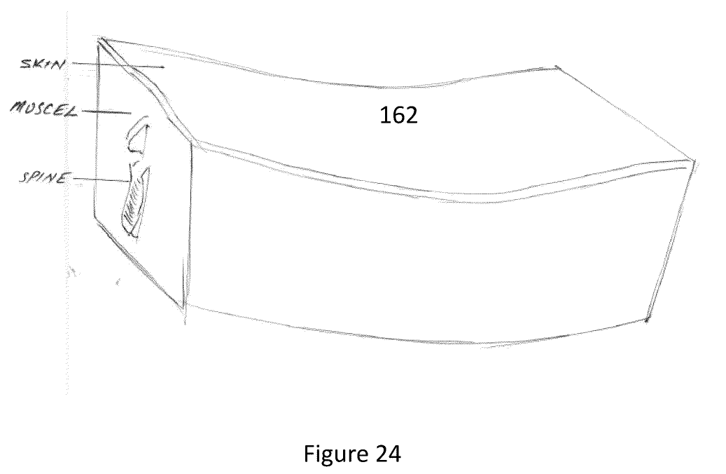

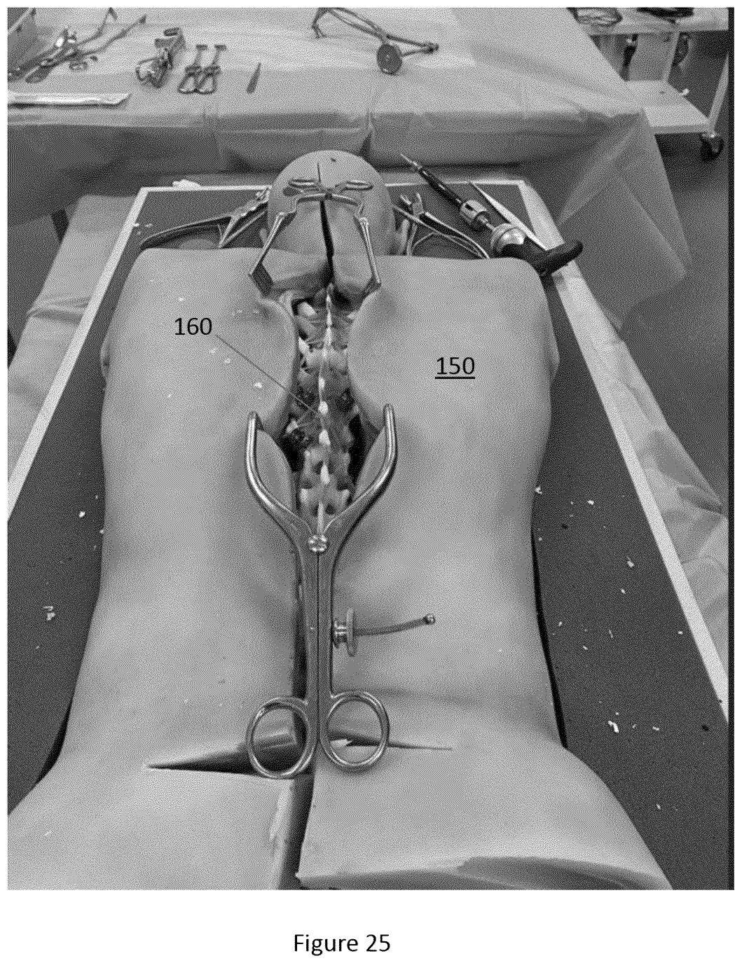

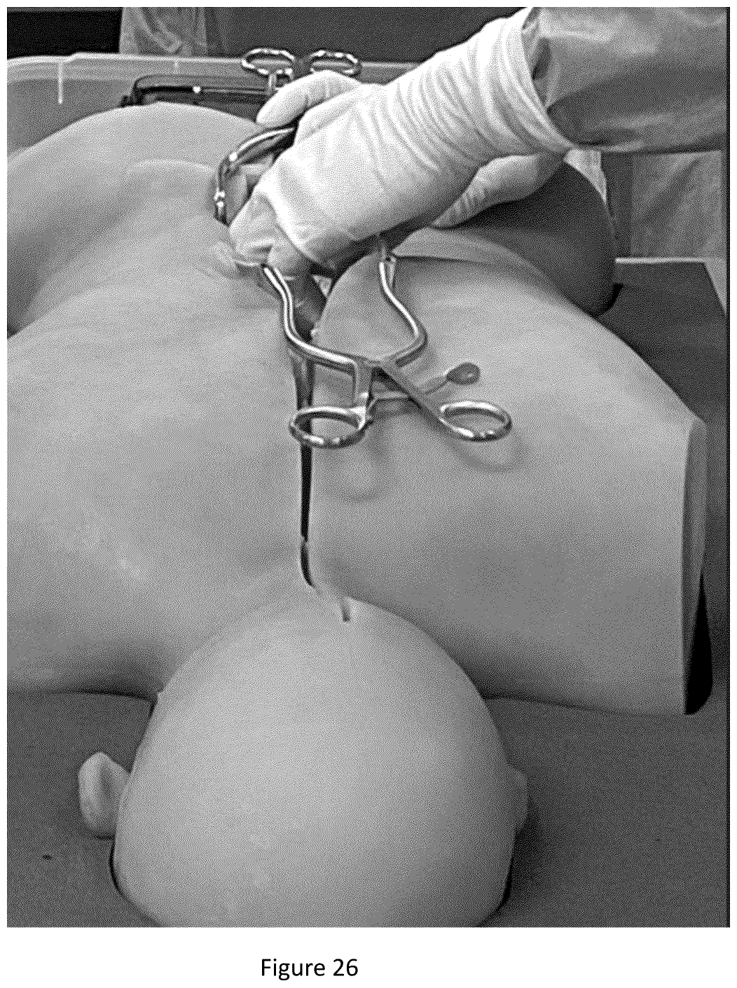

In FIG. 22 the vertebrae L1 to L5 are shown together with sacrum, soft tissues such as veins arteries and other components that would be present in the spine system. These structures are encased in muscle mould 164 to form the cassette. In FIG. 23 the spinal structures are shown internal of the cassette for illustration purposes; however, since muscle mould 162 is actually a muscle coloured red/brown material, the actual view of the cassette is shown in FIG. 24. The cassette looks like a piece of meat and is realistic when cut into with a knife. FIGS. 25 and 26 show the model comprising the base model 150 including an abdomen 150 and thoracic and head 152. The upper layer of skin of the model can close over cavity 154 to provide a realistic looking model. In an embodiment, the skin is formed around the anatomy by casting in a mould that is slightly larger than the muscle mould, the skin thereby able to form an outer layer over layers of fat and facia. A surgical operation can be performed on the model as shown. The surgeon (human or robot) can cut into the out skin, cut through fat, muscle to access the spine.

It is to be understood that, if any prior art publication is referred to herein, such reference does not constitute an admission that the publication forms a part of the common general knowledge in the art, in Australia or any other country.

In the claims which follow and in the preceding description of the disclosure, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the disclosure.

Any promises made in the present description should be understood to relate to some embodiments of the disclosure and are not intended to be promises made about the disclosure as a whole. Where there are promises that are deemed to apply to all embodiments of the disclosure, the applicant/patentee reserves the right to later delete them from the description and does not rely on these promises for the acceptance or subsequent grant of a patent in any country.

1. A surgical training model, comprising:
a plurality of adjacent cassettes joined together to simulate a spine, the cassettes comprising spacer cassettes each being removable and replaceable with one or more anatomy cassette(s) that simulates an anatomy and or pathology in the spine,
wherein adjacent cassettes comprise: joined cassettes with a join, or unattached cassettes when not joined, the join between attached cassettes being substantially fixed so that, other than allowing for unattached cassettes, the attached cassettes do not move relative to one another about said join.

2. The model of claim 1, wherein at least each anatomy cassette is 3D printed.

3. The model of claim 1, wherein the at least each anatomy cassette is manufactured by a combination of manufacturing processes.

4. The model of claim 1, wherein each spacer cassette is removably associatable to an adjacent spacer cassette or adjacent anatomy cassette to provide a simulated human spine with a substantially full range of natural movement.

5. The model of claim 1, wherein each anatomy cassette is provided with one or more of a pathology, disease, deformity, dislocation, fracture or injury of any kind comprising a lodged foreign body, or any alignment that can cause pain.

6. The model of claim 1, wherein the model is a tailored anatomical model based on patient dimensions and each anatomy cassette simulates a specific anatomy, pathology, disease, deformity, dislocation, fracture or injury of any kind comprising a lodged foreign body, or any alignment that can cause pain, that could be subject to surgical intervention.

7. A surgical training model, comprising:
a base simulating at least the abdomen of a body;
the base comprising an elongate cavity therein for receiving cassettes;
a plurality of adjacent cassettes arranged together in the cavity to simulate a spine, the cassettes comprising spacer cassettes each being removable and replaceable with one or more anatomy cassette(s) that simulate an anatomy and or pathology in the spine,
wherein adjacent cassettes comprise: joined cassettes with a join, or unattached cassettes when not joined, the join between attached cassettes being substantially fixed by location in the cavity so that, other than allowing for unattached cassettes, the attached cassettes do not move relative to one another when joined.

8. A method of providing training of a surgical procedure, the system comprising
providing a surgical training model according to claim 1,
operating or allowing others to perform an operation on the anatomy cassette(s) in the model, the operation being robotic, endoscopic or open surgery;
providing feedback on the operation to assist in surgical training.
